(19) United States
(12) Patent Application Publication
(10) Pub. No.: US 2020/0242597 A1
(43) Pub. Date: Jul. 30, 2020

(54) AUDITING SYSTEM USING A TRUSTED AND CRYPTOGRAPHICALLY SECURE DATABASE

(71) Applicant: Alessandro Baretta, San Jose, CA (US)

(72) Inventor: Alessandro Baretta, San Jose, CA (US)

(21) Appl. No.: 16/775,442

(22) Filed: Jan. 29, 2020

Related U.S. Application Data
(60) Provisional application No. 62/798,201, filed on Jan. 29, 2019.

(51) Int. Cl. G06Q 20/38; H04L 9/32; H04L 9/30

(52) U.S. Cl. CPC G06Q 20/3823; G06Q 20/389; H04L 9/30; H04L 9/3242; H04L 9/3247

(57) ABSTRACT

Secure and verifiable transaction records of an entity's reportable events, for financial or GRC auditing purposes, are generated in a data processing system by grouping one or more transaction records into a transaction batch having a unique identifier, and encrypting the transaction batch. An encryption key record is generated having information therein that can be used to decrypt the encrypted transaction batch. A cryptographic signature of the transaction batch is also generated that can be used to verify that the transaction batch has not subsequently been tampered with. A cryptographic signature record that can be used to derive the cryptographic signature from the transaction batch is also generated. The encrypted transaction batch and its associated cryptographic signature record are stored in a data repository.

### CROSS-REFERENCE TO RELATED APPLICATIONS

This application claims the benefit of U.S. provisional patent application no. 62/798,201 filed Jan. 29, 2019.

### BACKGROUND

The concepts described herein relate to auditing in general, and in particular to Governance, Risk and Compliance (GRC) auditing and financial auditing.

### BRIEF SUMMARY

According to one example, provided is a method executed by one or more data processors, of generating transaction records of the reporting entity's reportable events, comprising: grouping one or more digital transaction records into the transaction batch, the transaction batch having a unique identifier; encrypting the transaction batch; generating an encryption key record having information therein that can be used to decrypt the encrypted transaction batch; generating an cryptographic signature of the transaction batch that can be used to verify that the transaction batch has not subsequently been tampered with; generating an cryptographic signature record that can be used to derive the cryptographic signature from the transaction batch; and storing the encrypted transaction batch and its associated cryptographic signature in a data repository.

The method may further comprise encrypting the encryption key record using a public key of the reporting entity; encrypting the cryptographic signature record using the private key of the reporting entity; and storing the encrypted encryption key record and the encrypted cryptographic signature record in the independent data repository. The method may still further comprise providing the encryption key record and the cryptographic signature record to an auditing entity and encrypting the encryption key record and the cryptographic signature record with a public key of the auditing entity.

In one example, encrypting the transaction batch may comprise encrypting the transaction batch using an encryption algorithm and a transaction batch encryption key; and the encryption key record may comprise encryption algorithm parameters, the transaction batch encryption key, and the unique identifier of the transaction batch. Also, generating the cryptographic signature may comprise generating a transaction block hash value by applying a hash algorithm to the transaction batch and the cryptographic signature record may comprise hash algorithm parameters, a hash algorithm key and the unique identifier of the transaction batch.

In another example, provided is a method executed by one or more data processors, of extracting and verifying transaction records of a reporting entity's reportable events from information comprising: an encrypted transaction batch having a unique identifier, the transaction batch including at least one transaction record, an encryption key record including information that can be used to decrypt the encrypted transaction batch, the encryption key record being encrypted with a public key of an auditing entity, a stored cryptographic signature of the transaction batch that can be used to verify that the transaction batch has not been tampered with, and a cryptographic signature record including information that can be used to derive the stored cryptographic signature from the transaction batch. In this example, the method comprises decrypting the encryption key record using a private key of the auditing entity, to form a decrypted encryption key record; decrypting the encrypted transaction batch using information obtained from the decrypted encryption key record, to form a decrypted transaction batch; generating a computed cryptographic signature from the decrypted transaction batch using information obtained from the cryptographic signature record; and comparing the computed cryptographic signature with the stored cryptographic signature to determine if the at least one transaction records in the encrypted transaction batch has been tampered with.

In this example, the encryption key record may comprise a name of and parameters of an encryption algorithm, an encryption key, and an ID of the transaction batch and the encryption key record may comprise a name of and parameters of an encryption algorithm, an encryption key, and an ID of the transaction batch. The cryptographic signature function may be a hash algorithm and the cryptographic signature key may be a hash key.

According to another example, provided is a non-transitory machine-readable medium including instructions which, when read by a machine, cause the machine to perform some or all of the operations described above.

### BRIEF DESCRIPTION OF THE DRAWINGS

To easily identify the discussion of any particular element or act, the most significant digit or digits in a reference number refer to the figure number in which that element is first introduced.

FIG. 1 is a diagrammatic representation of audit evidence gathering and storage system in which the present disclosure may be deployed, in one example.

FIG. 2 is a diagrammatic representation of the reporting entity server 102 of FIG. 1.

FIG. 3 is a flowchart depicting an exemplary audited entity protocol for generating and storing transaction records in a data storage service 104 accordance with one example.

FIG. 4 is a flowchart for generating a cryptographic signature of a transaction batch in accordance with one example.

FIG. 5 is a flowchart illustrating how an audited entity can share transaction data with an auditing entity in accordance with one example.

FIG. 6 is a flowchart depicting an exemplary business associate protocol for generating and storing transaction records in a data storage service 104 in accordance with one example.

FIG. 7 is a flowchart for generating a cryptographic signature of each transaction batch, stored by a business associate, in accordance with one example.

FIG. 8 is a flowchart illustrating how an audited entity can share transaction data, uploaded by a business associate, in accordance with one example.

FIG. 9 is a flowchart showing an exemplary protocol executed for or by an auditing entity to retrieve relevant information in accordance with one example.

FIG. 10 is a continuation of the flowchart of FIG. 9.

FIG. 11 is a flowchart showing the provision of evidence to an auditing entity in accordance with another example.

FIG. 12 is a flowchart, in a blockchain implementation, for generating a cryptographic signature of each transaction batch in accordance with one example.

FIG. 13 is a flowchart illustrating how an audited entity can share transaction data with an auditing entity in a blockchain implementation in accordance with one example.

FIG. 14 is a flowchart for generating a cryptographic signature of each transaction batch stored by a business associate to the blockchain network in accordance with one example.

FIG. 15 is a flowchart illustrating how, in a blockchain implementation, an audited entity can share transaction data provided by a business associate in accordance with one example.

FIG. 16 is a flowchart showing an exemplary protocol executed for or by an auditing entity to retrieve relevant information that has been stored by a reporting entity in a blockchain implementation in accordance with one example.

FIG. 17 is a continuation of the flowchart of FIG. 16.

FIG. 18 is block diagram showing a software architecture within which the present disclosure may be implemented, in some examples.

FIG. 19 is a diagrammatic representation of a machine in the form of a computer system within which a set of instructions may be executed for causing the machine to perform any one or more of the methodologies discussed herein, in accordance with some examples.

### DETAILED DESCRIPTION

The following description is made with reference to the use case of GRC teams monitoring the compliance of their organization, or of relevant third parties, with applicable operational policies and risk management regulations, but the same technology would apply to finance teams and their effort to collect and accurately report financial transaction data to a financial auditing firm.

GRC has been defined as “the integrated collection of capabilities that enable an organization to reliably achieve objectives, address uncertainty and act with integrity.” GRC teams promote and implement their organization's operational policies and monitor compliance by gathering and auditing “evidence”: data documenting the organization's operations whose inspection enables an auditor to either confirm compliance with applicable policies and regulations or identify non-conformities. GRC teams have both internal and external audit responsibilities, both in an active and a passive role.

In an internal and active role, a GRC team gathers evidence data about internal processes and assesses compliance with applicable policies to produce an internal audit report for the company's management and the board of directors.

In an internal and passive role, a GRC team gathers evidence data about internal processes and submits it to external auditors, including auditing firms and relevant third-party stakeholders, such as clients and investors.

In an external and active role, a GRC team gathers policies and evidence data from third parties (e.g. vendors) about their respective internal policies and produces an audit report for internal use.

In an external and passive role, a GRC team gathers official audit reports from third parties (vendors) and assesses them.

Much of the effort of GRC teams is expended in gathering evidence data and checking it for compliance with either internal policies or applicable regulations (e.g. SOC 2, Sarbanes-Oxley, ISO 27001, etc.) Consequently, GRC teams would benefit from computer-based systems to a gather such evidence data in a tamper-proof way, and verify same, where it can be tested against applicable audit rules, whether internally defined or mandated by applicable regulations.

The audit evidence gathering and storage system disclosed herein is equally applicable to financial audits. In the context of financial audits, relevant actors are the finance departments of companies subjected to audit requirements, their auditors, and relevant third parties called on to confirm information provided to the auditing firm by the company.

For ease of understanding, the following non-limiting exemplary terms will be used herein:

Audited entity: an entity subjected to reporting and auditing requirements. Business associate: an entity that engages in financial transactions or other business with the audited entity.

Reporting entity: either an audited entity or a business associate.

Auditing firm: a third-party entity selected by the audited entity to provide assurance services.

Third party stakeholder: a business associate or a potential business associate who demands to audit certain financial or GRC data of the audited entity.

Auditing entity: Either an auditing firm or a third-party stakeholder requesting access.

Audit evidence user: an individual affiliated with an auditing entity, who is granted access to certain financial or GRC data of the audited entity.

Evidence data: Data collected in the course of the business entity's day to day operations, which the audited entity may intend to disclose to audit users, in order to permit them to confirm the accuracy of the claims of the audited entity (financial reports, GRC procedures) or to identify non-conformities.

Transaction record: a record of a reportable event or transaction, including the identity of the reporting entity. A transaction record may be in one of any standard data transmission and storage formats such as CSV, XML, JSON. If the reporting entity has an audit evidence gathering and storage system ID, then this system ID is included in the transaction record.

Transaction batch: a set of records (preferably of homogeneous type) that are collected into a single submission and stored in a block.

Block: a single and distinct record stored in the audit evidence gathering and storage system.

Block id: a unique identifier for a given block.

An example scenario will now be described, illustrating how the audit evidence gathering and storage system may be used in the context of complex assurance and auditing requirements. In this example, the audited entity is Company Co., business associates are Bank Corp., Cloud Vendor LLC and Client Inc while the auditing entities are Financial Auditors LLP, Risk Assurance LLP

Company Co. is subjected to financial reporting requirements and files audited financial reports with federal regulators every year. Additionally, Company Co. has implemented a GRC process that aims to comply with the various internal control standards, including SOC2. Company Co. has engaged Financial Auditors LLP to audit its financial report and Risk Assurance LLP to audit its internal controls framework and produce a SOC2 report. In the course of its business, Company Co. stores evidence data relating both to its financial transactions and to its internal control processes to the system.

Whenever Company Co. makes a purchase or a sale, it records the transaction in its accounting system. At the end of each day, it records a copy of the full list of purchase and sale transactions to the audit evidence gathering and storage system. Because Company Co. receives payments from customers and makes payments to vendors through Bank Corp., Financial Auditors LLP requests access to Bank Corp.'s records to validate the accuracy of Company Co.'s accounting. Therefore, per Company Co.'s request, Bank Corp. submits encrypted copies of each one of Company Co.'s financial transactions to the audit evidence gathering and storage system as evidence data, by invoking a service or agent layer API whenever a payment is processed. At the end of the fiscal year, Company Co. grants Financial Auditors LLP access on the audit evidence gathering and storage system to only its financial transaction data, including transaction data submitted by Bank Corp., which Financial Auditors LLP uses to validate Company Co.'s financial report.

Company Co. makes use of Cloud Vendor LLC's computing and data storage services. In order to collect evidence data demonstrating compliance with its internal controls, Company Co. requests that Cloud Vendor LLC periodically submit a report on Company Co.'s cloud system configuration. In order to fulfil Company Co.'s request, Cloud Vendor LLC opts to run an agent every night at midnight that scans Company Co.'s account, records the system configuration, and submits it to the audit evidence gathering and storage system via a service layer API. At the time of the SOC2 audit, Company Co. grants Risk Assurance LLP access to only its GRC evidence data, including cloud system configuration data submitted by Cloud Vendor LLC.

Company Co. desires to do business with Client Inc. Client Inc.'s internal controls require that Company Co. provide to Client Inc. its SOC2 audit report. Upon inspection of the SOC2 audit report, Client Inc. requests to be allowed to inspect and audit Company Co's cloud configuration data. Company Co. therefore grants Client Inc. access to only cloud configuration data submitted to the audit evidence gathering and storage system by Cloud Vendor LLC.

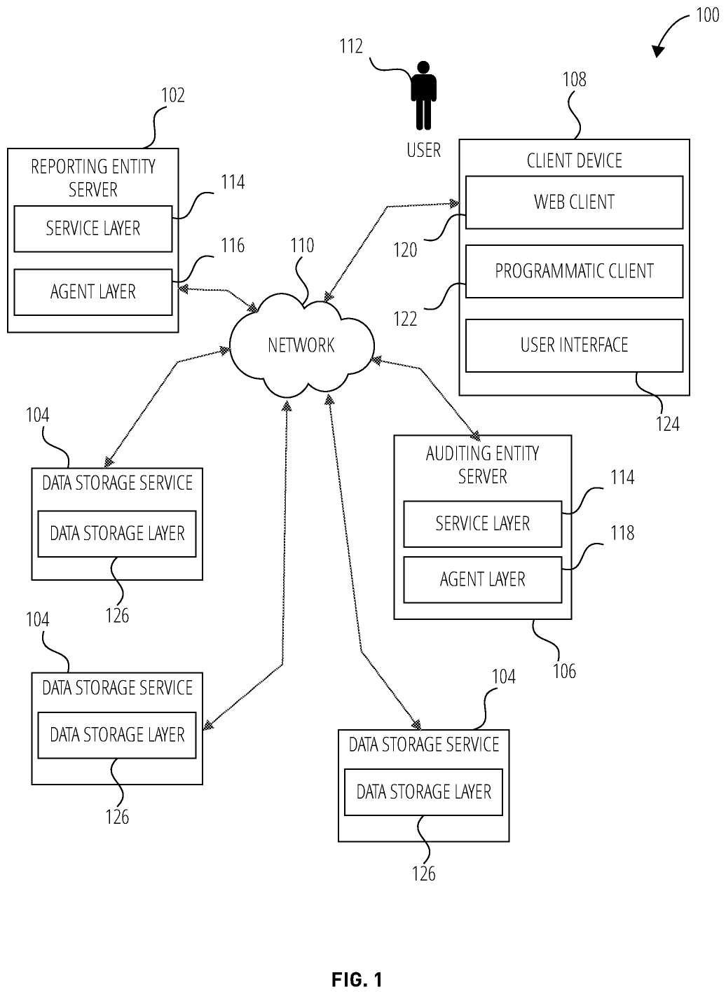

FIG. 1 is a diagrammatic representation of an audit evidence gathering and storage system 100 in which example embodiments of the present disclosure may be implemented or deployed.

The system comprises a reporting entity server 102, at least one data storage service 104, an auditing entity server 106, and a client device 108. These devices communicate over network 110.

The reporting entity server 102 includes a service layer 114 and an agent layer 116. The service layer 116 provides authorized personnel with network access to the data storage service 104 in order to store new encrypted transaction records (usually audit evidence) in the form of blocks, search through its data records in the data storage service 104 and retrieve and decrypt one or more blocks. To ensure consistency of the blocks, the service layer does not support deleting or updating any previously stored data. The agent layer 116 autonomously collects data from the relevant IT subsystems for recording in the data storage service 104. The reporting entity server 102 is either hosted by or provided as a service to a reporting entity.

The data storage service 104 is cryptographically secure and stores transaction records in blocks. Each block contains a cryptographically secure timestamp (e.g., RFC 3161, the “Internet X.509 Public Key Infrastructure Time-Stamp Protocol”), representing proof that the record contained in the block was created at or before the timestamp.

In one embodiment, data storage service 104 is a centralized storage subsystem, such as a relational database, which is hosted by a service provider. In another embodiment, the data storage service 104 is provided in the form of a distributed ledger such as blockchain. In such an embodiment, there are multiple data storage services 104 as shown, typically hosted by a number of independent service providers that collaborate to receive, store, retrieve and transmit blocks as is known in the blockchain art. Each data storage service 104 includes a data storage layer 126 that would typically include one or more databases and database servers.

An auditing entity server 106 includes a service layer 114. The service layer 116 provides authorized personnel with network access to the data storage service 104 in order to search through a reporting entity's data records and retrieve and decrypt one or more blocks. The auditing entity server 106 may include an agent layer 118, which may be the same as or of reduced functionality compared to the agent layer 116 of the reporting entity server 102. The auditing entity server 106 is either hosted by or provided as a service to an auditing entity.

Aspects of the system are accessed by a user 112 using a client device 108.

A reporting entity server 102 provides server-side functionality via the network 110 to a networked user device, in the form of the client device 108, associated with the user 112. A web client 120 (e.g., a browser) and a programmatic client 122 (e.g., an “app”) are hosted and execute on the client device 108. The client device also includes a user interface 124 by means of which the user 112 can interact with the client device 108.

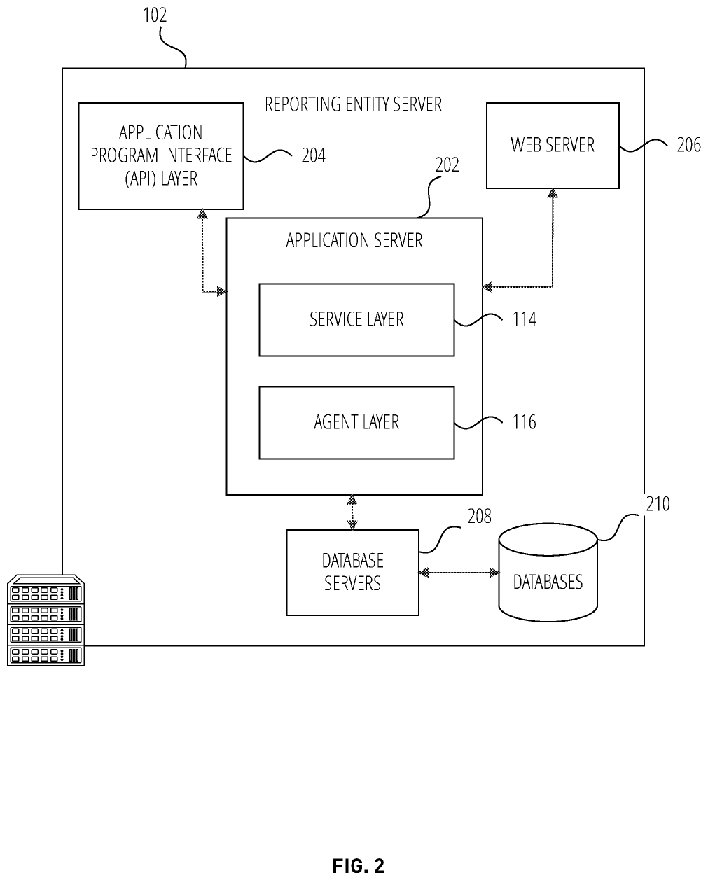

FIG. 2 is a diagrammatic representation showing the reporting entity server 102 in more detail.

An Application Program Interface (API) layer 204 and a web server 206 provide respective programmatic and web interfaces to reporting entity server 102. A specific application server 202 hosts the service layer 114 and the agent layer 116, which includes components, modules and/or applications to perform the above-described functions.

The client device 108 communicates with the service layer 114 of the reporting entity server 102 via the web interface supported by the web server 206. Similarly, the programmatic client 122 communicates with the service layer 114 of the reporting entity server 102 via the programmatic interface provided by the Application Program Interface (API) layer 204.

The application server 202 is shown to be communicatively coupled to database servers 208 that facilitate access to an information storage repository or databases 210. In an example embodiment, the databases 210 includes storage devices from which the service layer 114 collects data for recording in a data storage service 104.

An auditing entity server 106 has the same or similar structure and functionality as reporting entity server 102 as described with reference to FIG. 2. In such a case, the user 112 is associated with an auditing entity and accesses the auditing entity server 106 using the client device 108 to perform tasks appropriate to the auditing entity's role.

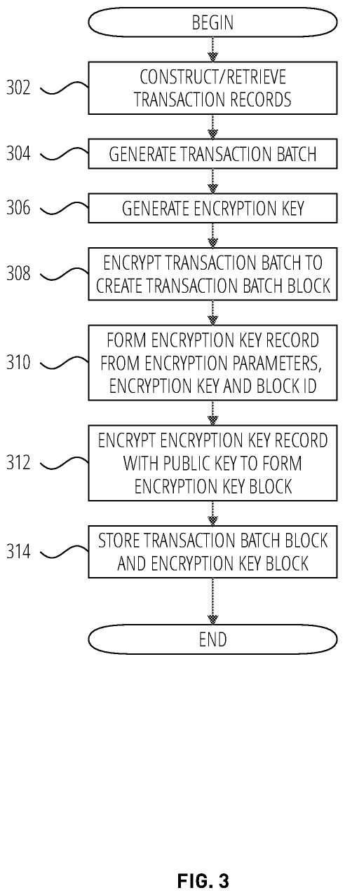

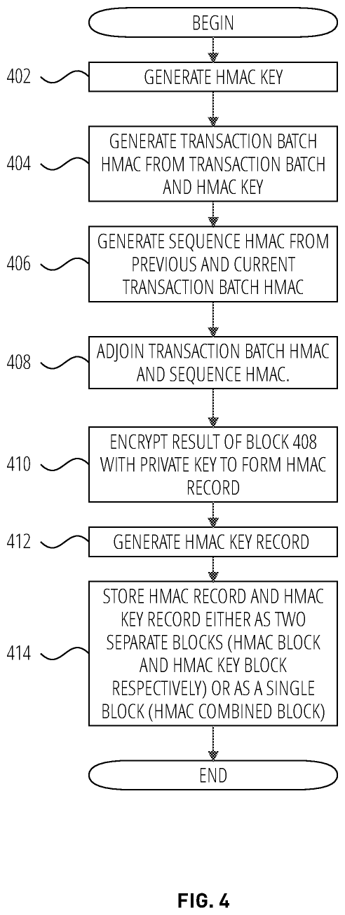

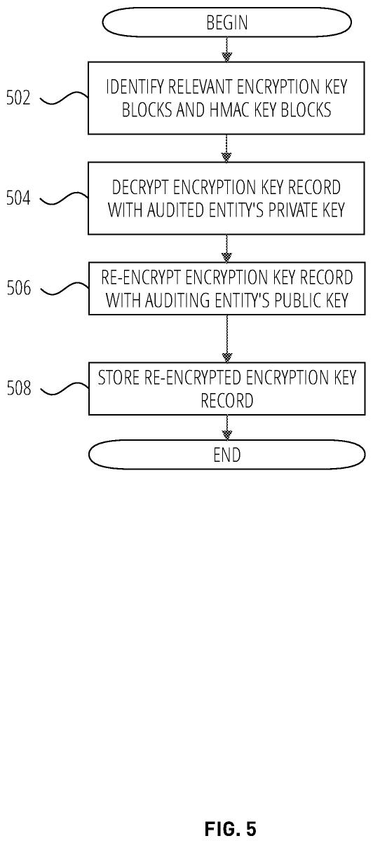

FIG. 3, FIG. 4 and FIG. 5 are flowcharts showing an exemplary protocol executed for or by an audited entity.

FIG. 3 is a flowchart depicting an exemplary audited entity protocol for generating and storing transaction records in a data storage service 104.

For every reportable transaction, in block 302, the agent layer 116 of the reporting entity server 102 constructs or retrieves one or more transaction records from information in the databases 210. Such records can be represented in one of any standard data transmission and storage formats such as CSV, XML, JSON. Each transaction record identifies any counterparty to the transaction, e.g. the name of a vendor. If the counterparty is connected with the audit evidence gathering and storage system 100, then the counterparty's system ID is included in the transaction record. Transaction records may be retrieved or generated automatically or on the prompting of a user 112.

At block 304, a transaction batch is formed by collecting or more transaction records in a single digital object (such as a file) to which the agent layer 116 assigns a new UUID (Universally Unique ID). The audited entity may optionally store the transaction batch on a data storage service 104 to make it immediately and (possibly) continuously available to its auditing entity or entities, and to authorized internal or third-party audit users.

If the audited entity opts to record the transaction batch in a data storage service 104, a random encryption key is generated at block 306 (using either a software pseudo-random number generator, a hardware random number generator, or an operating system level entropy source).

The encryption key is used to encrypt the transaction batch (using a secure industry standard algorithm such as AES-256) at block 308 to form a transaction batch block. The encryption key is of the appropriate bit length and format depending on the chosen encryption algorithm.

At block 310, an encryption key record is formed by adjoining the name and parameters of the encryption algorithm, the encryption key, and the block id of the transaction batch block.

The encryption key record is encrypted with the audited entity's public key (using an asymmetric cipher such as RSA or ECDSA) at block 312 to form an encryption key block. The ID of the public key used to encrypt the encryption key record is recorded with the encryption key block, permitting the audited entity to identify this block as directed to itself

The encrypted transaction batch block and encryption key block are optionally stored (at block 314) in the data storage service 104 as a single block.

FIG. 4 is a flowchart for generating a cryptographic signature of each transaction batch, thus providing a technical means for an auditing entity to ensure that any given transaction batch has not been tampered with after having been constructed. In this example, the cryptographic signature is generated using a hash algorithm known as HMAC (sometimes expanded to either “keyed-Hash Message Authentication Code” or “Hash-based Message Authentication Code”)

The audited entity generates a random HMAC key at block 402 and uses it to compute the HMAC of the transaction batch (the transaction batch HMAC) at block 404. The transaction batch HMAC is computed using a cryptographically secure, industry standard algorithm such as HMAC-SHA-256 or HMAC-SHA-3. The HMAC key is of an appropriate bit length and format depending on the chosen HMAC algorithm.

The current transaction batch HMAC is adjoined to the transaction batch HMAC of the transaction batch immediately preceding the current one, reported by the same entity, and the HMAC (the sequence HMAC) of this composite record is computed in block 406.

The transaction batch HMAC and the sequence HMAC are adjoined in block 408 and is encrypted with the audited entity's private key in block 410 to form an HMAC record. HMAC records are decryptable with the reporting entity's public key to allow anybody who is a member of the audit evidence gathering and storage system 100 to ensure that evidence data has not been tampered with, even though they may not have access to the evidence data itself. That is, the encryption in this case serves as a digital signature rather than as encryption per se. As an alternative to encrypting, the transaction batch HMAC and the sequence HMAC may instead be signed with a digital signature.

An HMAC key record is generated at block 412 by adjoining the name and parameters of the HMAC function, the HMAC key, the UUID of the transaction batch, the block id of the HMAC block, the UUID and block id of the HMAC key record of the transaction batch immediately preceding the current one, reported by the same entity, and the block id of the HMAC block.

The HMAC record and HMAC key record may be stored at block 414 in the data storage service 104 either as two separate blocks (the HMAC block and HMAC key block respectively) or as a single block (the HMAC combined block) in data storage service 104. If the HMAC record and HMAC key record are reported in an HMAC combined block, the block id of the HMAC block can be omitted (as it would be the block id of the combined HMAC record and HMAC key record). The HMAC record and HMAC KEY record are indexed by the UUID of the transaction batch, so that given the transaction batch UUID the storage layer can quickly identify the corresponding HMAC record and HMAC KEY record. The HMAC record and HMAC KEY record are indexed by the UUID of the transaction batch, so that given the transaction batch UUID the storage layer can quickly identify the corresponding HMAC record and HMAC KEY record.

FIG. 5 is a flowchart illustrating how an audited entity can share transaction data with an auditing entity. At any time, the audited entity may select an auditing entity from among those participating in the audit evidence gathering and storage system 100 with which to share its transaction data. To do so, it is necessary to provide the auditing entity with the ability to decrypt relevant transaction batches.

The agent layer 116 of the audited entity's reporting entity server 102 firstly at scans through the data storage service 104 at block 502 and identifies every encryption key block and HMAC key block stored by the audited entity itself in the relevant date range and/or based on other criteria such as the nature of the transaction. For each of these records the agent layer 116 does the following.

It decrypts the encryption key record at block 504 with the audited entity's private key (corresponding to the public key above) using the same asymmetric algorithm that was used to encrypt it.

The cleartext (decrypted) encryption key record is then re-encrypted with the auditing entity's public key (using an asymmetric cipher such as RSA or ECDSA, whichever is implied by the public key of the auditing entity) at block 506. The newly encrypted encryption key record is then stored (at block 508) to the data storage service 104 as a separate block, this time accessible to the auditing entity. The ID of the public key used to encrypt the encryption key record is recorded with the encryption key block, permitting the auditing entity to identify this block as directed to it.

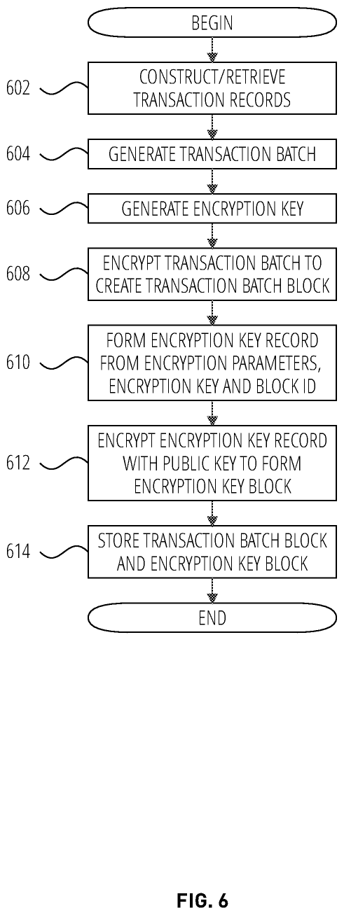

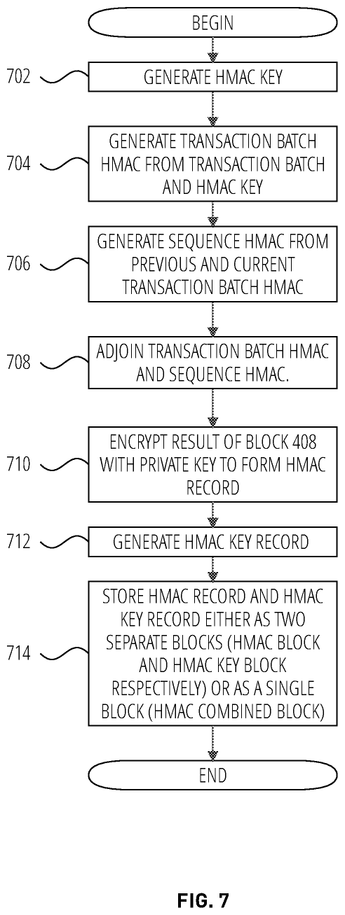

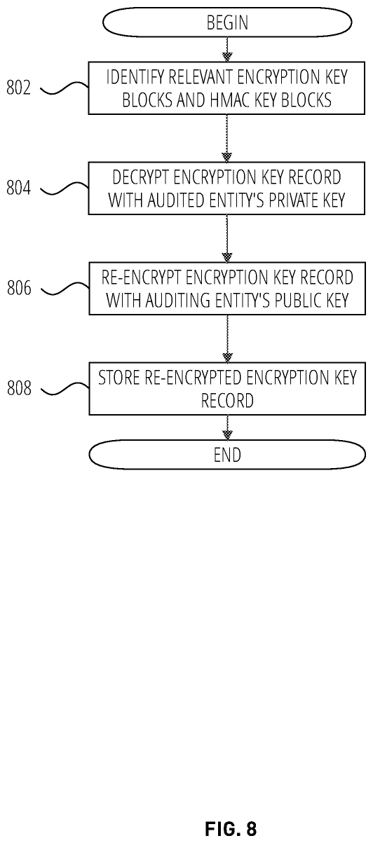

FIG. 6, FIG. 7 and FIG. 8 are flowcharts showing an exemplary protocol executed for or by a business associate of an audited entity. As can be seen from the following description and the figures themselves, these are primarily adaptations of the methods described with reference to FIG. 3, FIG. 4 and FIG. 5

FIG. 6 is a flowchart depicting an exemplary business associate protocol for generating and storing transaction records in a data storage service 104.

For every reportable transaction, in block 602, the agent layer 116 of the reporting entity server 102 of the business associate constructs or retrieves one or more transaction records from information in the databases 210. Such records can be represented in one of any standard data transmission and storage formats such as CSV, XML, JSON. The counterparty to the transaction, being the audited entity, is always identified in the transaction record by its audit evidence gathering and storage system 100 ID.

At block 604, a transaction batch is formed by collecting one or more records representing transactions between the business associate and the audited entity in a single digital object (such as a file) to which the agent layer 116 assigns a new UUID (Universally Unique ID). The business associate may optionally store the transaction batch on the data storage service 104 to make it immediately and (possibly) continuously available to the audited entity's auditing entity or entities, and to authorized internal or third-party audit users.

When the business associate opts to record the transaction batch in a data storage service 104, a random encryption key is generated at block 606 (using either a software pseudo-random number generator, a hardware random number generator, or an operating system level entropy source).

The encryption key is used to encrypt the transaction batch (using a secure industry standard algorithm such as AES-256 at block 608) to form a transaction batch block. The encryption key is of the appropriate bit length and format depending on the chosen encryption algorithm.

At block 610, an encryption key record is formed by adjoining the name and parameters of the encryption algorithm, the encryption key, and the block id of the transaction batch block.

The encryption key record is encrypted with the audited entity's public key (using an asymmetric cipher such as RSA or ECDSA) at block 612 to form an encryption key block. The ID of the public key used to encrypt the encryption key record is recorded with the encryption key block, permitting the audited entity to identify this block as directed to it.

The encrypted transaction batch block and encryption key block are stored in the data storage service 104 at block 614.

FIG. 7 is a flowchart for generating a cryptographic signature of each transaction batch, stored by a business associate, thus providing a technical means for an auditing entity to ensure that any given transaction batch has not been tampered with after having been constructed.

The business associate generates a new random HMAC key at block 702 and uses it to compute the HMAC of the transaction batch (transaction batch HMAC) at block 704. The transaction batch HMAC is computed using a cryptographically secure, industry standard algorithm such as HMAC-SHA-256 or HMAC-SHA-3. The HMAC key is of an appropriate bit length and format depending on the chosen HMAC algorithm.

The current transaction batch HMAC is adjoined to the transaction batch HMAC of the transaction batch immediately preceding the current one, reported by the same entity, and the HMAC of this composite record is computed (sequence HMAC) in block 706.

The transaction batch HMAC and the sequence HMAC are adjoined in block 708, encrypted with the business associate's private key to form an HMAC record in block 710. HMAC records are decryptable with the reporting entity's public key to allow anybody who is a member of the audit evidence gathering and storage system 100 to ensure that evidence data has not been tampered with, even though they may not have access to the evidence data itself. That is, the encryption in this case serves as a digital signature rather than as encryption per se. As an alternative to encrypting, the transaction batch HMAC and the sequence HMAC may instead be signed with a digital signature.

An HMAC key record is generated at block 712 by adjoining the name and parameters of the HMAC function, the HMAC key, and the UUID of the transaction batch, and block id of the HMAC block, the UUID and block id of the HMAC key record of the transaction batch immediately preceding the current one, reported by the same entity, and the block id of the HMAC block.

The HMAC record and HMAC key record may be stored in the data storage service 104 at block 714 either as two separate blocks (HMAC block and HMAC key block respectively) or as a single block (HMAC combined block) in data storage service 104. If the HMAC record and HMAC key record are reported in an HMAC combined block, the block id of the HMAC block can be omitted (as it would be the block id of the combined HMAC record and HMAC key record). The HMAC record and HMAC KEY record are indexed by the UUID of the transaction batch, so that given the transaction batch UUID the storage layer can quickly identify the corresponding HMAC record and HMAC KEY record.

FIG. 8 is a flowchart illustrating how an audited entity can share transaction data, uploaded by a business associate, with an auditing entity. At any time, the audited entity may select an auditing entity from among those participating in the audit evidence gathering and storage system 100 with which to share its transaction data. To do so, it is necessary to provide the auditing entity with the ability to decrypt relevant transaction batches.

The agent layer 116 of the audited entity's reporting entity server 102 firstly scans through the data storage service 104 at block 802 and identifies every encryption key block and HMAC key block in the relevant date range (and/or based on other criteria such as the nature of the transaction) from each relevant business associate. For each of these records the agent layer 116 does the following.

It decrypts the encryption key record at block 804 with the audited entity's private key (corresponding to the public key above) using the same asymmetric algorithm that was used to encrypt it.

The cleartext (decrypted) encryption key record is then re-encrypted with the auditing entity's public key (using an asymmetric cipher such as RSA or ECDSA, whichever is implied by the public key of the auditing entity) at block 806. The newly encrypted encryption key record is then stored at block 808 to the data storage service 104 as a separate block, this time accessible to the auditing entity. The ID of the public key used to encrypt the encryption key record is recorded with the encryption key block, permitting the audited entity to identify this block as directed to the auditing entity.

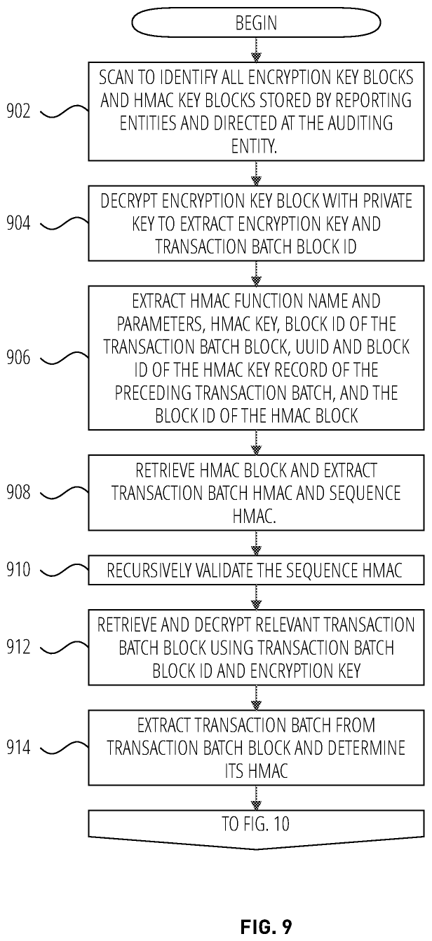

FIG. 9 is a flowchart showing an exemplary protocol executed for or by an auditing entity to retrieve relevant information that has been stored by a reporting entity on a data storage service 104. The auditing entity server 106 (typically via the agent layer 118) performs the following steps.

At block 902, the auditing entity server 106 scans the data storage service 104 to identify all encryption key blocks and HMAC key blocks (or HMAC combined blocks) stored by reporting entities (i.e. audited entities or business associates) and directed at the auditing entity (that is, encrypted with the auditing entity's public key).

The auditing entity server 106 decrypts each identified encryption key block with the auditing entity's private key at block 904 and extracts the encryption key and the block id of the transaction batch block.

For each HMAC key record, the auditing entity server 106 extracts the HMAC function name and parameters, the HMAC key, the block id of the transaction batch block, the UUID and block id of the HMAC key record of the transaction batch immediately the current one, reported by the same entity, at block 906.

The auditing entity server 106 retrieves the corresponding HMAC record (the HMAC record is either part of the same block as the HMAC KEY record or its block ID is contained in the HMAC KEY record) from the data storage service 104 and extracts the transaction batch HMAC and the sequence HMAC at block 908.

At block 910, the auditing entity server 106 recursively validates the sequence HMAC of the HMAC record by adjoining the transaction batch HMAC in the current HMAC record to the transaction batch HMAC of the transaction batch immediately preceding the current one, reported by the same entity, then computing the HMAC of this composite record, then comparing the result with the sequence HMAC in the current HMAC record.

If the audited entity has opted to store the transaction batches on the data storage service 104, for any HMAC block, the auditing entity server 106 at block 912 retrieves the relevant transaction batch block from the data storage service 104 using the transaction batch block ID retrieved in either block 904 or block 906 and decrypts it with the encryption key obtained in block 904.

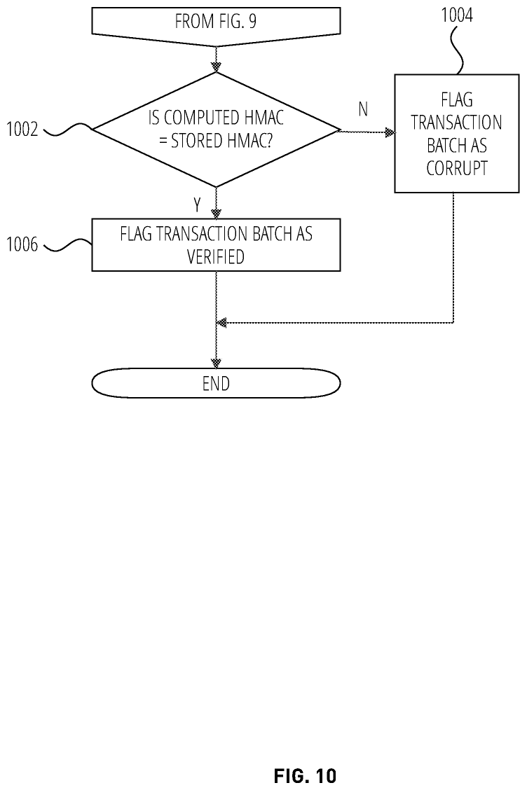

The transaction batch is extracted from the transaction batch block that was decrypted in block 912 and its HMAC is determined in block 914 using the HMAC function, parameters and HMAC key extracted in block 906 from the HMAC key record. The flowchart continues in FIG. 10.

The computed HMAC is compared with the stored HMAC in decision block 1002. If the computed HMAC does not match the stored HMAC, the transaction batch is flagged as corrupt in block 1004. If the computed HMAC matches the stored HMAC, then the transaction batch is accepted and flagged as verified in block 1006.

At this point the flowchart ends and the verified transaction batches can be used by the auditing entity to perform its GRC and/or financial auditing functions.

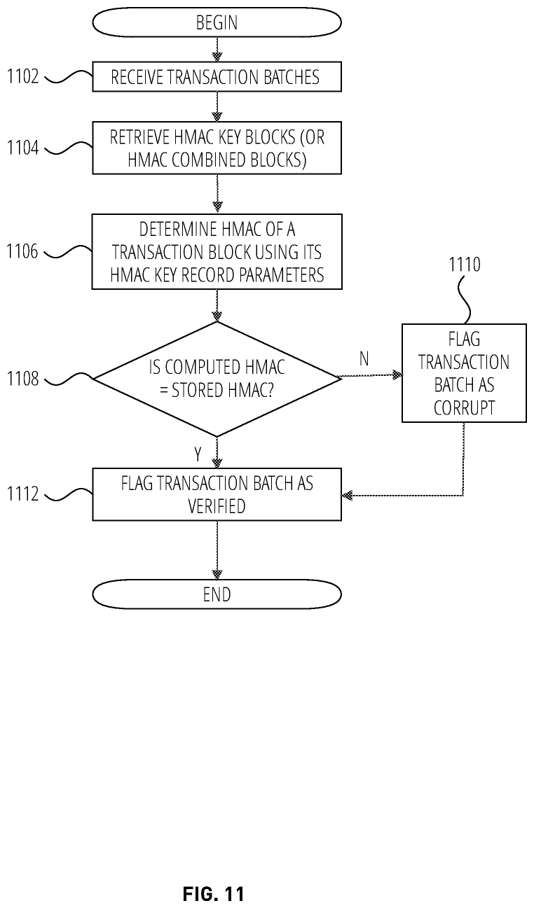

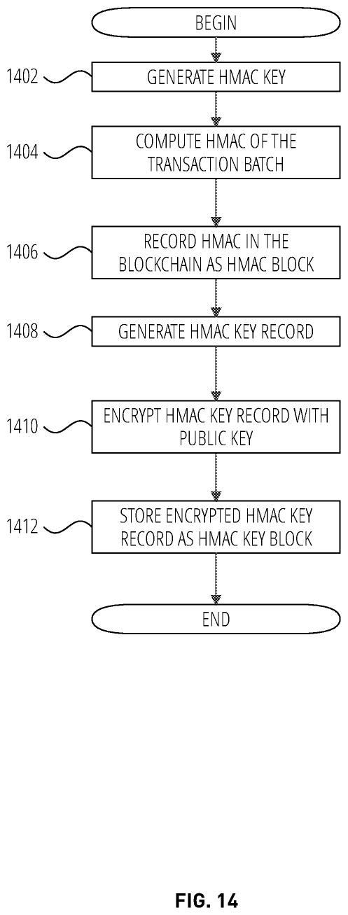

FIG. 11 is a flowchart showing the provision of evidence to an auditing entity if the audited entity has opted not to report the transaction batches on either a data storage service 104 of the audit evidence gathering and storage system 100 or on a blockchain network. Note however that the audited entity will still have stored corresponding cryptographic signatures (i.e. HMAC records) as discussed above with reference to FIG. 4 above, or with reference to FIG. 14 below in a blockchain implementation.

The appropriate transaction batches (including the UUID of each transaction batch) are received by the auditing entity server 106 from the audited entity at block 1102. Transaction batch selection can either be done by audited entity personnel or autonomously by agent layer 118. The selected transaction batches can be sent using any data transmission scheme (e.g. email, ftp, sftp, scp, http, smtp, smb, nfs, etc.). Transaction batch data may also be conveyed to the auditing entity by means of the transfer of one or more physical storage devices, such as disks, tapes, or solid-state memories.

At block 1104, the auditing entity server 106 retrieves all HMAC key blocks (or HMAC combined blocks) corresponding to the UUIDs of the received transaction batches, from the data storage service 104 (or the blockchain network as discussed below).

The HMAC of a transaction batch from among those obtained in block 1102 is determined in block 1106 using the HMAC function, parameters and the HMAC key specified in the associated HMAC key record.

The computed HMAC is compared with the stored HMAC in decision block 1108. If the computed HMAC does not match the stored HMAC, the transaction batch is flagged as corrupt in block 1110. If the computed HMAC matches the stored HMAC, then the transaction batch is accepted and flagged as verified in block 1112.

At this point the flowchart ends and the verified transaction batches can be used by the auditing entity to perform its GRC and/or financial auditing functions.

In a blockchain implementation of an exemplary audited entity protocol for generating and storing transaction records in a blockchain network, the procedure for generating and storing transaction batch blocks and encryption key blocks is substantially the same as illustrated and described with reference to FIG. 3, with minor changes as needed and as will be apparent to someone of ordinary skill in the art. For example, the data storage services 104 will be part of a blockchain network. Furthermore, if a counterparty to a transaction is part of the blockchain network, its blockchain network ID will be included in transaction records.

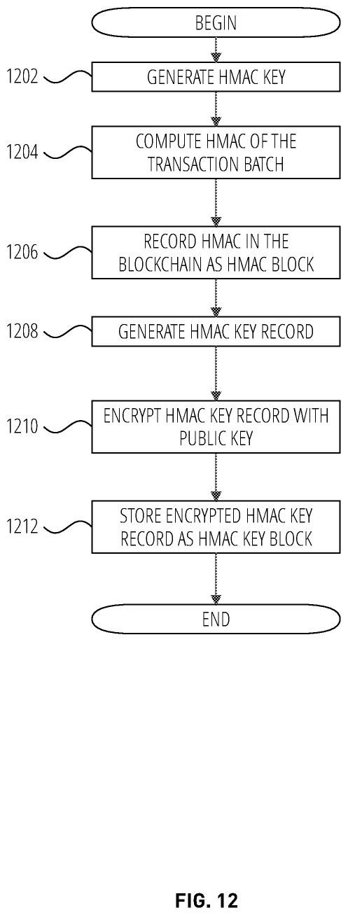

FIG. 12 is a flowchart, in a blockchain implementation, for generating a cryptographic signature of each transaction batch, thus providing a technical means for an auditing entity to ensure that any given transaction batch has not been tampered with after having been constructed.

The audited auditing entity server 106 generates a new random HMAC key at block 1202 and uses it to compute the HMAC of a transaction batch at block 1204. The transaction batch HMAC is computed using a cryptographically secure, industry standard algorithm such as HMAC-SHA-256 or HMAC-SHA-3. The HMAC key is of an appropriate bit length and format depending on the chosen HMAC algorithm.

The HMAC is then recorded in the blockchain network as an HMAC block, at block 1206.

An HMAC key record is generated in block 1208 by adjoining the name and parameters of the HMAC function, the HMAC key, and the UUID of the transaction batch, and the block id of the HMAC block.

The HMAC key record is encrypted with the reporting entity's public key (using an asymmetric cipher such as RSA or ECDSA, whichever is implied by the public key) at block 1210 and stored in the blockchain as an HMAC key block at block 1212.

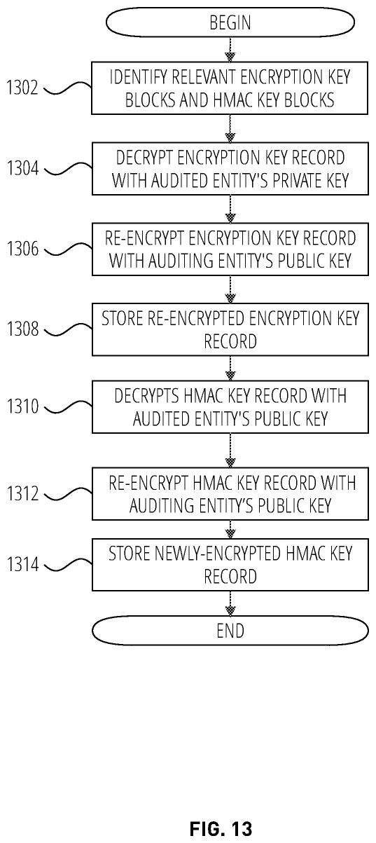

FIG. 13 is a flowchart illustrating how an audited entity can share transaction data with an auditing entity in a blockchain implementation.

At any time, the audited entity may select an auditing entity from among those participating in the blockchain network with which to share its transaction data. The auditing entity will need to be able to decrypt the transaction batches provided by the audited entity. The agent layer 116 of the auditing entity server 106 scans through the blockchain network in block 1302 and identifies every encryption key block and HMAC key block stored by the auditing entity itself in the relevant date range and/or based on other criteria such as the nature of the transaction.

In block 1304 the agent layer 116 decrypts the encryption key record with the audited entity's private key (corresponding to the public key mentioned above with respect to FIG. 12.), using the same asymmetric algorithm as was used to encrypt the encryption key record.

The cleartext encryption key record is then re-encrypted in block 1306 with the auditing entity's public key (using an asymmetric cipher such as RSA or ECDSA, whichever is implied by the public key of the auditing entity). The newly encrypted encryption key record is then stored to the blockchain as a separate block, this time accessible to the auditing entity, as shown in block 1308.

The reporting entity must also provide the auditing entity with the ability to verify the integrity of the data using the HMACs of each transaction batch.

The agent layer 116 decrypts (in block 1310) the HMAC key record retrieved in block 1302 with the audited entity's private key, as was done with the encryption key record.

In block 1312, the cleartext HMAC key record is then re-encrypted with the auditing entity's public key (using an asymmetric cipher such as RSA or ECDSA, whichever is implied by the public key of the auditing entity). The newly encrypted HMAC key record is then stored in block 1314 to the blockchain as a separate block, this time accessible to the auditing entity.

In a blockchain implementation of an exemplary business associate protocol for generating and storing transaction records in a blockchain network, the procedure for generating and storing transaction batch blocks and encryption key blocks is substantially the same as illustrated and described with reference to FIG. 6, with minor changes as needed and as will be apparent to someone of ordinary skill in the art. For example, the data storage services 104 will be part of a blockchain network. Furthermore, since the counterparty to a transaction is the audited entity, which is part of the blockchain network, its blockchain network ID will be included in transaction records.

FIG. 14 is a flowchart for generating a cryptographic signature of each transaction batch, stored by a business associate to the blockchain network, thus providing a technical means for an auditing entity to ensure that any given transaction batch has not been tampered with after having been constructed.

The business associate reporting entity server 102 generates a random HMAC key at block 1402 and uses it to compute the HMAC of the transaction batch (transaction batch HMAC) at block 1404. The transaction batch HMAC is computed using a cryptographically secure, industry standard algorithm such as HMAC-SHA-256 or HMAC-SHA-3. The HMAC key is of an appropriate bit length and format depending on the chosen HMAC algorithm.

The HMAC is then stored in the blockchain network as an HMAC block in block 1406

An HMAC key record is formed by adjoining the name and parameters of the HMAC function, the HMAC key, and the UUID of the transaction batch, and block id of the transaction batch block, and the block id of the HMAC block as shown in block 1408.

In block 1410 the HMAC key record is encrypted with the audited entity's public key (using an asymmetric cipher such as RSA or ECDSA, whichever is implied by the public key) and stored in the blockchain as an HMAC key block as shown in block 1412.

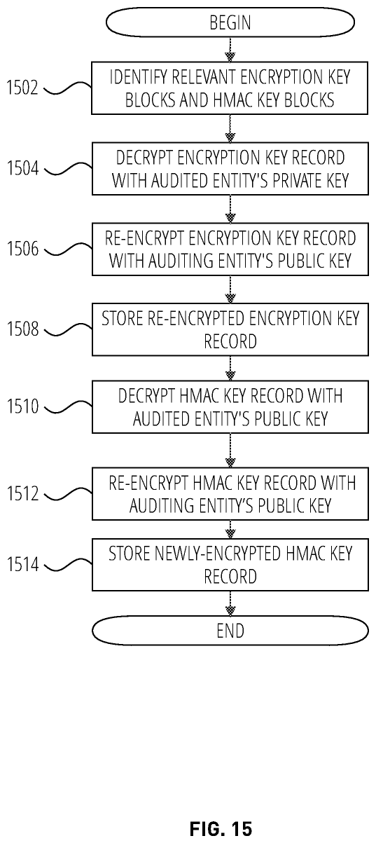

FIG. 15 is a flowchart illustrating how, in a blockchain implementation, an audited entity can share transaction data stored in the blockchain network by a business associate, with an auditing entity.

At any time, the audited entity may select an auditing entity from among those participating in the blockchain network with which to share its transaction data that has been recorded in the blockchain network by a business associate. The auditing entity will need to be able to decrypt the transaction batches provided by the business associate. The agent layer 116 of the auditing entity server 106 scans through the blockchain network in block 1502 and identifies every encryption key block and HMAC key block stored by every relevant business associate in the relevant date range and/or based on other criteria such as the nature of the transaction.

In block 1504 the agent layer 116 decrypts the encryption key record with the audited entity's private key (corresponding to the public key mentioned above with respect to FIG. 14.), using the same asymmetric algorithm as was used to encrypt the encryption key record.

The cleartext encryption key record is then re-encrypted in block 1506 with the auditing entity's public key (using an asymmetric cipher such as RSA or ECDSA, whichever is implied by the public key of the auditing entity). The newly encrypted encryption key record is then stored to the blockchain as a separate block, this time accessible to the auditing entity, as shown in block 1508.

The reporting entity must also provide the auditing entity with the ability to verify the integrity of the data using the HMACs of each transaction batch.

The agent layer 116 decrypts (in block 1510) the associated HMAC key record with the audited entity's private key, as was done with the encryption key record.

In block 1512, the cleartext HMAC key record is then re-encrypted with the auditing entity's public key (using an asymmetric cipher such as RSA or ECDSA, whichever is implied by the public key of the auditing entity). The newly encrypted HMAC key record is then stored in block 1514 to the blockchain as a separate block, this time accessible to the auditing entity.

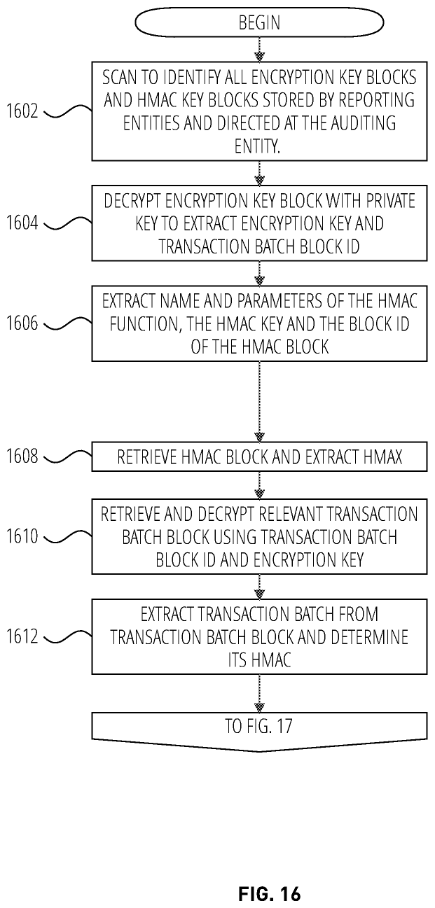

FIG. 16 is a flowchart showing an exemplary protocol executed for or by an auditing entity in a blockchain implementation to retrieve relevant information that has been stored by a reporting entity on in a blockchain network. The auditing entity server 106 (typically via the agent layer 118) performs the following steps.

At block 1602, the auditing entity server 106 scans the blockchain network to identify all encryption key blocks and HMAC key blocks stored by relevant reporting entities and directed at the auditing firm (that is, encrypted with the auditing firm's public key).

The auditing entity server 106 decrypts, using its private key, the encryption key block and extracts the encryption key and the block id of the transaction batch bloc at block 1604.

In block 1606 the auditing entity server 106 decrypts the HMAC key block using its private key and extracts the name and parameters of the HMAC function, the HMAC key and the block id of the HMAC block.

The auditing firm, in block 1608 retrieves the HMAC block from the blockchain and decrypts it with the secret key obtained in block 1602 and extracts the HMAC.

The auditing entity server 106 in block 1610 retrieves the corresponding transaction batch block from the blockchain network using the transaction batch block ID obtained in block 1606 and decrypts it with the encryption key obtained in block 1604.

In block 1612, the transaction batch is extracted from the transaction batch block and its HMAC is determined using the HMAC function, parameters and HMAC key specified in the HMAC key block and extracted in block 1606.

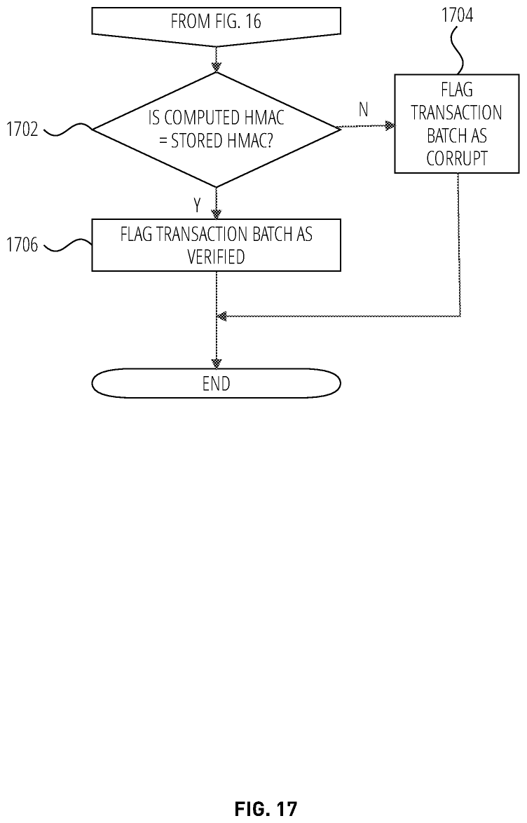

The flowchart then continues in FIG. 17.

The computed HMAC is compared with the stored HMAC in decision block 1702. If the computed HMAC does not match the stored HMAC, the transaction batch is flagged as corrupt in block 1704. If the computed HMAC matches the stored HMAC, then the transaction batch is accepted and flagged as verified in block 1706.

At this point the flowchart ends and the verified transaction batches can be used by the auditing entity to perform its GRC and/or financial auditing functions.

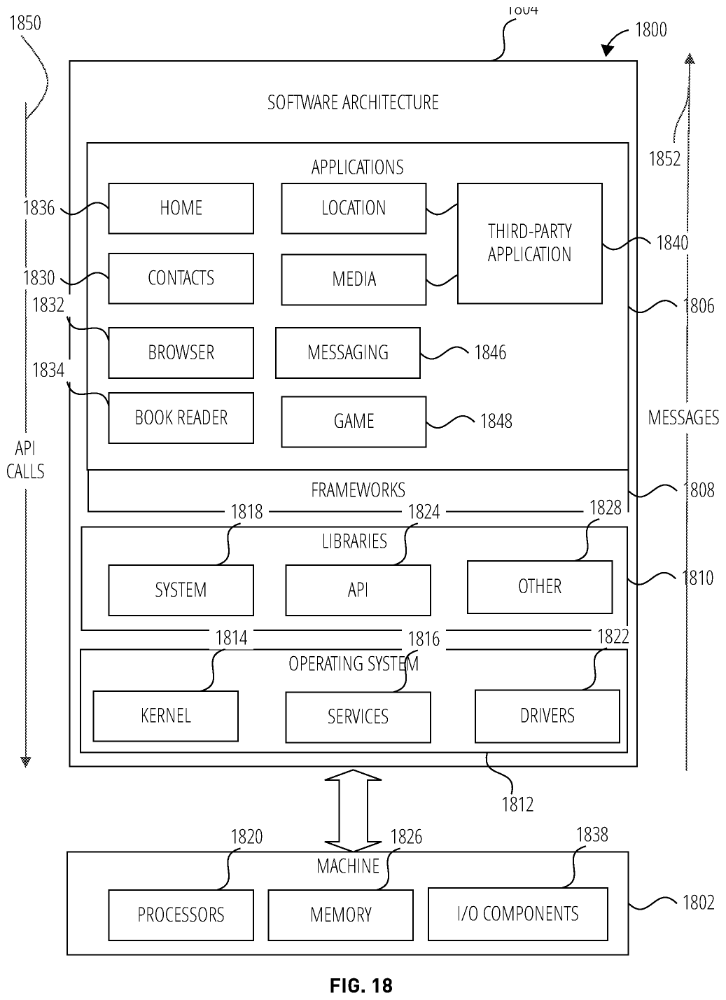

FIG. 18 is a block diagram 1800 illustrating a software architecture 1804, which can be installed on any one or more of the devices described herein. The software architecture 1804 is supported by hardware such as a machine 1802 that includes processors 1820, memory 1826, and I/O components 1838. In this example, the software architecture 1804 can be conceptualized as a stack of layers, where each layer provides a particular functionality. The software architecture 1804 includes layers such as an operating system 1812, libraries 1810, frameworks 1808, and applications 1806. Operationally, the applications 1806 invoke API calls 1850 through the software stack and receive messages 1852 in response to the API calls 1850.

The operating system 1812 manages hardware resources and provides common services. The operating system 1812 includes, for example, a kernel 1814, services 1816, and drivers 1822. The kernel 1814 acts as an abstraction layer between the hardware and the other software layers. For example, the kernel 1814 provides memory management, Processor management (e.g., scheduling), Component management, networking, and security settings, among other functionality. The services 1816 can provide other common services for the other software layers. The drivers 1822 are responsible for controlling or interfacing with the underlying hardware. For instance, the drivers 1822 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1810 provide a low-level common infrastructure used by the applications 1806. The libraries 1810 can include system libraries 1818 (e.g., C standard library) that provide functions such as memory allocation functions, string manipulation functions, mathematic functions, and the like. In addition, the libraries 1810 can include API libraries 1824 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1810 can also include a wide variety of other libraries 1828 to provide many other APIs to the applications 1806.

The frameworks 1808 provide a high-level common infrastructure that is used by the applications 1806. For example, the frameworks 1808 provide various graphical user interface (GUI) functions, high-level resource management, and high-level location services. The frameworks 1808 can provide a broad spectrum of other APIs that can be used by the applications 1806, some of which may be specific to a particular operating system or platform.

In an example embodiment, the applications 1806 may include a home application 1836, a contacts application 1830, a browser application 1832, a book reader application 1834, a location application 1842, a media application 1844, a messaging application 1846, a game application 1848, and a broad assortment of other applications such as a third-party application 1840. The e applications 1806 are programs that execute functions defined in the programs. Various programming languages can be employed to create one or more of the applications 1806, structured in a variety of manners, such as object-oriented programming languages (e.g., Objective-C, Java, or C++) or procedural programming languages (e.g., C or assembly language). In a specific example, the third-party application 1840 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1840 can invoke the API calls 1850 provided by the operating system 1812 to facilitate functionality described herein.

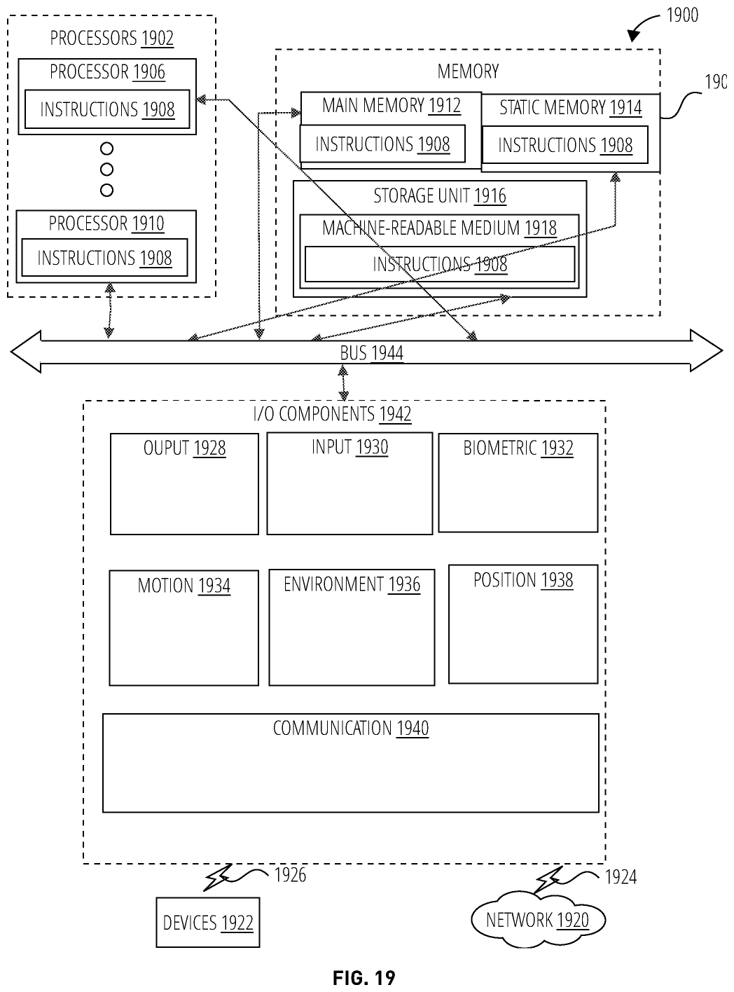

FIG. 19 is a diagrammatic representation of the machine 1900 within which instructions 1908 (e.g., software, a program, an application, an applet, an app, or other executable code) for causing the machine 1900 to perform any one or more of the methodologies discussed herein may be executed. For example, the instructions 1908 may cause the machine 1900 to execute any one or more of the methods described herein. The instructions 1908 transform the general, non-programmed machine 1900 into a particular machine 1900 programmed to carry out the described and illustrated functions in the manner described. The machine 1900 may operate as a standalone device or may be coupled (e.g., networked) to other machines. In a networked deployment, the machine 1900 may operate in the capacity of a server machine or a client machine in a server-client network environment, or as a peer machine in a peer-to-peer (or distributed) network environment. The machine 1900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1908, sequentially or otherwise, that specify actions to be taken by the machine 1900. Further, while only a single machine 1900 is illustrated, the term “machine” shall also be taken to include a collection of machines that individually or jointly execute the instructions 1908 to perform any one or more of the methodologies discussed herein.

The machine 1900 may include processors 1902, memory 1904, and I/O components 1942, which may be configured to communicate with each other via a bus 1944. In an example embodiment, the processors 1902 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a processor 1906 and a processor 1910 that execute the instructions 1908. The term “Processor” is intended to include multi-core processors that may comprise two or more independent processors (sometimes referred to as “cores”) that may execute instructions contemporaneously. Although FIG. 19 shows multiple processors 1902, the machine 1900 may include a single Processor with a single core, a single Processor with multiple cores (e.g., a multi-core Processor), multiple processors with a single core, multiple processors with multiples cores, or any combination thereof.

The memory 1904 includes a main memory 1912, a static memory 1914, and a storage unit 1916, both accessible to the processors 1902 via the bus 1944. The main memory 1904, the static memory 1914, and storage unit 1916 store the instructions 1908 embodying any one or more of the methodologies or functions described herein. The instructions 1908 may also reside, completely or partially, within the main memory 1912, within the static memory 1914, within machine-readable medium 1918 within the storage unit 1916, within at least one of the processors 1902 (e.g., within the Processor's cache memory), or any suitable combination thereof, during execution thereof by the machine 1900.

The I/O components 1942 may include a wide variety of components to receive input, provide output, produce output, transmit information, exchange information, capture measurements, and so on. The specific I/O components 1942 that are included in a particular machine will depend on the type of machine. For example, portable machines such as mobile phones may include a touch input device or other such input mechanisms, while a headless server machine will likely not include such a touch input device. It will be appreciated that the I/O components 1942 may include many other components that are not shown in FIG. 19. In various example embodiments, the I/O components 1942 may include output components 1928 and input components 1930. The output components 1928 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1930 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1942 may include biometric components 1932, motion components 1934, environmental components 1936, or position components 1938, among a wide array of other components. For example, the biometric components 1932 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1934 include acceleration sensor components (e.g., accelerometer), gravitation sensor components, rotation sensor components (e.g., gyroscope), and so forth. The environmental components 1936 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1938 include location sensor components (e.g., a GPS receiver Component), altitude sensor components (e.g., altimeters or barometers that detect air pressure from which altitude may be derived), orientation sensor components (e.g., magnetometers), and the like.

Communication may be implemented using a wide variety of technologies. The I/O components 1942 further include communication components 1940 operable to couple the machine 1900 to a network 1920 or devices 1922 via a coupling 1924 and a coupling 1926, respectively. For example, the communication components 1940 may include a network interface Component or another suitable device to interface with the network 1920. In further examples, the communication components 1940 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1922 may be another machine or any of a wide variety of peripheral devices (e.g., a peripheral device coupled via a USB).

Moreover, the communication components 1940 may detect identifiers or include components operable to detect identifiers. For example, the communication components 1940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1940, such as location via Internet Protocol (IP) geolocation, location via Wi-Fi® signal triangulation, location via detecting an NFC beacon signal that may indicate a particular location, and so forth.

The various memories (e.g., memory 1904, main memory 1912, static memory 1914, and/or memory of the processors 1902) and/or storage unit 1916 may store one or more sets of instructions and data structures (e.g., software) embodying or used by any one or more of the methodologies or functions described herein. These instructions (e.g., the instructions 1908), when executed by processors 1902, cause various operations to implement the disclosed embodiments.

The instructions 1908 may be transmitted or received over the network 1920, using a transmission medium, via a network interface device (e.g., a network interface Component included in the communication components 1940) and using any one of a number of well-known transfer protocols (e.g., hypertext transfer protocol (HTTP)). Similarly, the instructions 1908 may be transmitted or received using a transmission medium via the coupling 1926 (e.g., a peer-to-peer coupling) to the devices 1922.

What is claimed is:

1. A method, executed by one or more data processors, of generating transaction records of a reporting entity's reportable events, comprising:
grouping one or more digital transaction records into a transaction batch, the transaction batch having a unique identifier;
encrypting the transaction batch;
generating an encryption key record having information therein that can be used to decrypt the encrypted transaction batch;
generating a cryptographic signature of the transaction batch that can be used to verify that the transaction batch has not subsequently been tampered with;
generating a cryptographic signature record that can be used to derive the cryptographic signature from the transaction batch; and
storing the encrypted transaction batch and its associated cryptographic signature record in a data repository.

2. The method of claim 1 further comprising:
encrypting the encryption key record using a public key of the reporting entity;
encrypting the cryptographic signature record using a private key of the reporting entity; and
storing the encrypted encryption key record and the encrypted cryptographic signature record in the data repository.

3. The method of claim 2 further comprising:
retrieving the encrypted encryption key record and the encrypted cryptographic signature record from the data repository;
decrypting the encryption key record and the encrypted cryptographic signature record using the private key of the reporting entity;
re-encrypting the encryption key record and the cryptographic signature record with a public key of an auditing entity; and
storing the re-encrypted encryption key record and cryptographic signature record in the independent data repository, thereby facilitating access to the encryption key record and the cryptographic signature key record by the auditing entity.

4. The method of claim 1 further comprising:
providing the encryption key record and the cryptographic signature record to an auditing entity.

5. The method of claim 4 further comprising:
encrypting the encryption key record and the cryptographic signature record with a public key of the auditing entity.

6. The method of claim 1 wherein:
encrypting the transaction batch comprises encrypting the transaction batch using an encryption algorithm and a transaction batch encryption key; and
the encryption key record comprises encryption algorithm parameters, the transaction batch encryption key, and the unique identifier of the transaction batch.

7. The method of claim 1 wherein:
generating the cryptographic signature comprises generating a transaction block hash value by applying a hash algorithm to the transaction batch; and
the cryptographic signature record comprises hash algorithm parameters, a hash algorithm key and the unique identifier of the transaction batch.

8. A method, executed by one or more data processors, of extracting and verifying transaction records of a reporting entity's reportable events from information comprising:
an encrypted transaction batch having a unique identifier, the transaction batch including at least one transaction record,
an encryption key record including information that can be used to decrypt the encrypted transaction batch, the encryption key record being encrypted with a public key of an auditing entity,
a stored cryptographic signature of the transaction batch that can be used to verify that the transaction batch has not been tampered with, and
a cryptographic signature record including information that can be used to derive the stored cryptographic signature from the transaction batch, the method comprising:
decrypting the encryption key record using a private key of the auditing entity, to form a decrypted encryption key record;
decrypting the encrypted transaction batch using information obtained from the decrypted encryption key record, to form a decrypted transaction batch;
generating a computed cryptographic signature from the decrypted transaction batch using information obtained from the cryptographic signature record;
comparing the computed cryptographic signature with the stored cryptographic signature to determine if the at least one transaction records in the encrypted transaction batch has been tampered with.

9. The method of claim 8 wherein the encryption key record comprises a name of and parameters of an encryption algorithm, an encryption key, and an ID of the transaction batch.

10. The method of claim 8 wherein the cryptographic signature record comprises a name of and parameters of a cryptographic signature function, a cryptographic signature key and the unique identifier of the transaction batch.

11. The method of claim 10 wherein the cryptographic signature function is a hash algorithm and the cryptographic signature key is a hash key.

12. The method of claim 11 wherein the hash algorithm is an HMAC algorithm and the hash key is an HMAC key.

13. A non-transitory machine-readable medium including instructions which, when read by a machine, cause the machine to perform operations for generating transaction records of a reporting entity's reportable events, comprising:
grouping one or more digital transaction records into a transaction batch, the transaction batch having a unique identifier;
encrypting the transaction batch;
generating an encryption key record having information therein that can be used to decrypt the encrypted transaction batch;
generating a cryptographic signature of the transaction batch that can be used to verify that the transaction batch has not subsequently been tampered with;
generating a cryptographic signature record that can be used to derive the cryptographic signature from the transaction batch; and
storing the encrypted transaction batch and its associated cryptographic signature record in a data repository.

14. The non-transitory machine-readable medium of claim 13 including instructions which, when read by the machine, cause the machine to perform operations further comprising:
encrypting the encryption key record using a public key of the reporting entity;
encrypting the cryptographic signature record using a private key of the reporting entity; and
storing the encrypted encryption key record and the encrypted cryptographic signature record in the data repository.

15. The non-transitory machine-readable medium of claim 14 including instructions which, when read by the machine, cause the machine to perform operations further comprising:
retrieving the encrypted encryption key record and the encrypted cryptographic signature record from the data repository;
decrypting the encryption key record and the encrypted cryptographic signature record using the private key of the reporting entity;
re-encrypting the encryption key record and the cryptographic signature record with a public key of an auditing entity; and
storing the re-encrypted encryption key record and cryptographic signature record in the independent data repository, thereby facilitating access to the encryption key record and the cryptographic signature key record by the auditing entity

16. The non-transitory machine-readable medium of claim 13 including instructions which, when read by a machine, cause the machine to perform operations further comprising:
providing the encryption key record and the cryptographic signature record to an auditing entity.

17. The non-transitory machine-readable medium of claim 16 including instructions which, when read by a machine, cause the machine to perform operations further comprising:
encrypting the encryption key record and the cryptographic signature record with a public key of the auditing entity.

18. The non-transitory machine-readable medium of claim 13 including instructions which, when read by a machine, cause the machine to perform operations further comprising:
encrypting the transaction batch comprises encrypting the transaction batch using an encryption algorithm and a transaction batch encryption key; and
the encryption key record comprises encryption algorithm parameters, the transaction batch encryption key, and the unique identifier of the transaction batch.

19. The non-transitory machine-readable medium of claim 13 including instructions which, when read by a machine, cause the machine to perform operations further comprising:
generating the cryptographic signature comprises generating a transaction block hash value by applying a hash algorithm to the transaction batch; and
the cryptographic signature record comprises hash algorithm parameters, a hash algorithm key and the unique identifier of the transaction batch.
